(19) United States
(12) Patent Application Publication
(10) Pub. No.: US 2011/0206414 A1
(43) Pub. Date: Aug. 25, 2011

(54) METHOD FOR MANUFACTURING ELECTRIFYING ROLLER AND ELECTRIFYING ROLLER MANUFACTURED BY THE METHOD

(75) Inventors: Hirotaka Tagawa, Kanagawa (JP); Junichi Takano, Kanagawa (JP); Izumi Egashira, Kanagawa (JP); Daijirou Sirakura, Kanagawa (JP)

(73) Assignee: BRIDGESTONE CORPORATION, Chuo-ku, Tokyo (JP)

(21) Appl. No.: 13/059,823

(22) PCT Filed: Aug. 24, 2009
(86) PCT No.: PCT/JP2009/064740

§ 371 Date: May 12, 2011

(30) Foreign Application Priority Data
Aug. 22, 2008 (JP) 2008-214682

(51) Int. Cl. G03G 15/02; B05D 1/18; B05D 1/38; B05D 3/02; B05D 3/06

(52) U.S. Cl. 399/176; 427/512

(57) ABSTRACT

Provided are a method of manufacturing an electrifying roller in which a highly precise electrifying roller can be manufactured at a low cost and with more ease and an electrifying roller manufactured by the method.

Provided are a method of manufacturing electrifying rollers (10, 20) comprising a shaft (1), an elastic layer (2) formed on the periphery of the shaft (1), and a surface layer (3) formed on the periphery surface of the elastic layer (2), characterized in that the method comprises:
an immersing process in which said shaft is moved downward so that the longitudinal direction of the shaft (1) be perpendicular to the liquid level (8a) of a coating solution (8) containing an ultraviolet curing resin and immersed into the coating solution (8), and
an ultraviolet irradiation process in which the shaft (1) is lifted upward in the perpendicular direction after the immersing process, and at the same time an ultraviolet is irradiated on the periphery of the lifted shaft (1) in the longitudinal direction, and the elastic layer (2) is formed, and
electrifying rollers (10, 20) manufactured by the method.

### TECHNICAL FIELD

The present invention relates to a method of manufacturing an electrifying roller and an electrifying roller manufactured by the method (hereinafter, also referred to as “roller”), and particularly to a method of manufacturing an electrifying roller in which a highly precise electrifying roller can be manufactured at a low cost and with more ease and an electrifying roller manufactured by the method.

### BACKGROUND ART

Generally, in an electrophotography image forming apparatus such as a copier, a printer, a facsimile or the like, a roller which is provided with electrical conductivity such as a transfer roller, a developing roller, a toner supplying roller, an electrifying roller, a cleaning roller, an intermediate transfer roller, a belt driving roller or the like is employed for each process of the image forming apparatuses.

As such a conductive roller, an electrifying roller or the like has been known which is formed by providing an electrically conductive shaft made of metal or polymer with an elastic layer made of foamed or non-foamed rubber, and providing thereon one or more skin layers. As a method of manufacturing such an electrifying roller, for example, in the Patent Document 1, disclosed is a method of manufacturing a foam roller the method comprising a process of forming a foam, a process of pressing the foam into a cylindrical mold and curing the foam, a process of forming a coating film on the surface of the cylinder. In the Patent Document 2, disclosed is a method of manufacturing a foam roller, the method further comprising a process of forming a coating film by coating on the inner surface of a cylindrical mold which does not have a cleavage line on the inner surface of the cylinder and curing. Further, in the Patent Document 3, disclosed is a molding apparatus for a foam for a roller, wherein a through-hole is formed at the center of a lid molding, one side of the through-hole is set as a hole for injecting raw materials, the other side of the through-hole is set as a hole for inserting an axis of a roller. Still further, in the Patent Document 4, disclosed is a molding for an elastic roller in which a pipe is provided inside a cylindrical molding.

In the Patent Document 5, disclosed is a method of manufacturing a roller wherein a cap having an inlet for materials for an elastic layer is fitted to the both ends of a core bar, this bar is then installed in a molding die, materials for the elastic layer are injected from the inlet, a roller is formed and demolded, thereafter, an electrically conductive film is further formed on the surface of this elastic layer as required, and the cap is removed from this roller. Further, in the Patent Document 6, disclosed is a method for manufacturing a roller wherein a foam as the material for an elastic layer of a roller is injected in a cavity formed inside a molding die from the top end of the molding die, and air in the cavity is exhausted from the bottom of the molding die.

Still further, in the Patent Document 7, disclosed is a ring coater coating method wherein a coating layer of a roller is subjected to an ultraviolet irradiation process by an ultraviolet irradiating means in succession immediately after a coating process, and the ultraviolet irradiating means and the roller are moved relatively to cure the surface of the coating layer.

### RELATED ART DOCUMENT

### Patent Document

Patent Document 1: Japanese Unexamined Patent Application Publication No. H5-35110
Patent Document 2: Japanese Unexamined Patent Application Publication No. H8-50411
Patent Document 3: Japanese Unexamined Patent Application Publication No. H5-329855
Patent Document 4: Japanese Unexamined Patent Application Publication No. H8-150672
Patent Document 5: Japanese Unexamined Patent Application Publication No. H8-207172
Patent Document 6: Japanese Unexamined Patent Application Publication No. H8-281832

### Patent Document 7: Japanese Unexamined Patent Application Publication No. 2006-160771

### SUMMARY OF THE INVENTION

### Problems to be Solved by the Invention

However, the methods of the Patent Documents 1 to 6 have the following problems due to an electrifying roller having, on the periphery of a shaft, a urethane foam, an adhesion layer and an intermediate layer made of a water-based urethane coating, and a top layer made of a solvent-based coating:
(1) Because urethane foam casting needs a high precision molding, a large amount of money is required for the molding and a great care is required for the quality control of the molding to maintain the precision. Further, since consumables for casting members are needed, consumables cost is also required.
(2) Because a water-based urethane coating is applied in multiple layers, coating, drying at normal temperature and heat drying are performed repeatedly and it takes lots of time for manufacturing. Further, due to many processes, there are many check items about manufacturing such as quality control for coatings and control for drying conditions.
(3) High consumption of energy due to heat drying of coatings.

The ring coater coating method described in the Patent Document 7 can effectively prevent dripping, and can resolve problems of coating irregularities and ununiformity on a coating layer. However, in order to manufacture a high precision electrifying roller, strict adjustment of apparatus is required, and for this reason, a method of manufacturing an electrifying roller with more ease and with more precision is desired.

Accordingly, an object of the present invention is to overcome the above-mentioned problems and to provide a method of manufacturing an electrifying roller in which a highly precise electrifying roller can be manufactured at a low cost and with more ease and an electrifying roller manufactured by the method.

### Means for Solving the Problems

To solve the above-mentioned problems, the present inventors intensively studied to discover that a highly precise electrifying roller can be manufactured at a low cost and with more ease by immersing a shaft directly into a coating solution containing an ultraviolet curing resin, lifting the shaft accompanied by irradiation of an ultraviolet (UV), and curing the coating, thereby completing the present invention.

That is, the method of manufacturing an electrifying roller of the present invention is a method of manufacturing an electrifying roller comprising a shaft, an elastic layer formed on the periphery of said shaft, and a surface layer formed on the periphery surface of said elastic layer, wherein the method comprises:

an immersing process in which said shaft is moved downward so that the longitudinal direction of said shaft be perpendicular to the liquid level of a coating solution containing an ultraviolet curing resin and immersed into said coating solution, and

an ultraviolet irradiation process in which said shaft is lifted upward in the perpendicular direction after said immersing process, and at the same time an ultraviolet is irradiated on the periphery of lifted said shaft in the longitudinal direction, and said elastic layer is formed.

In the method of manufacturing an electrifying roller of the present invention, it is preferred that said immersing process and said ultraviolet irradiation process be performed in a plurality of times. Further, it is preferred that the irradiation intensity of the ultraviolet in said ultraviolet irradiation process be set at 0.1 to 4 W/cm², and after said ultraviolet irradiation process, an ultraviolet be irradiated again on said elastic layer at an irradiation intensity of 120 to 240 W/cm².

Still further, in the method of manufacturing an electrifying roller of the present invention, it is preferred that the lifting speed of said shaft upward in the perpendicular direction after said immersing process be 1.1 mm/s to 20 mm/s, and the viscosity of said coating solution be 0.5 to 10 Pa·s.

The electrifying roller of the present invention is characterized in that the roller is manufactured by said method of manufacturing an electrifying roller.

### Effects of the Invention

By the present invention, a method of manufacturing an electrifying roller in which a highly precise electrifying roller can be manufactured at a low cost and with more ease and an electrifying roller manufactured by the method can be provided.

### BRIEF DESCRIPTION OF THE DRAWINGS

FIG. 1 is a drawing illustrating one example of operations of an apparatus for manufacturing an elastic layer of an electrifying roller.

FIG. 2 is a drawing illustrating one example of an ultraviolet irradiation apparatus.

FIG. 3 is a drawing illustrating another example of an ultraviolet irradiation apparatus.

FIG. 4 is a drawing illustrating another example of an ultraviolet irradiation apparatus.

FIG. 5 is a drawing illustrating one example of an electrifying roller related to a preferred embodiment of the present invention.

FIG. 6 is a drawing illustrating another example of an electrifying roller related to a preferred embodiment of the present invention.

### MODES FOR CARRYING OUT THE INVENTION

Preferred embodiments of the present invention will now be described in detail with reference to the figures.

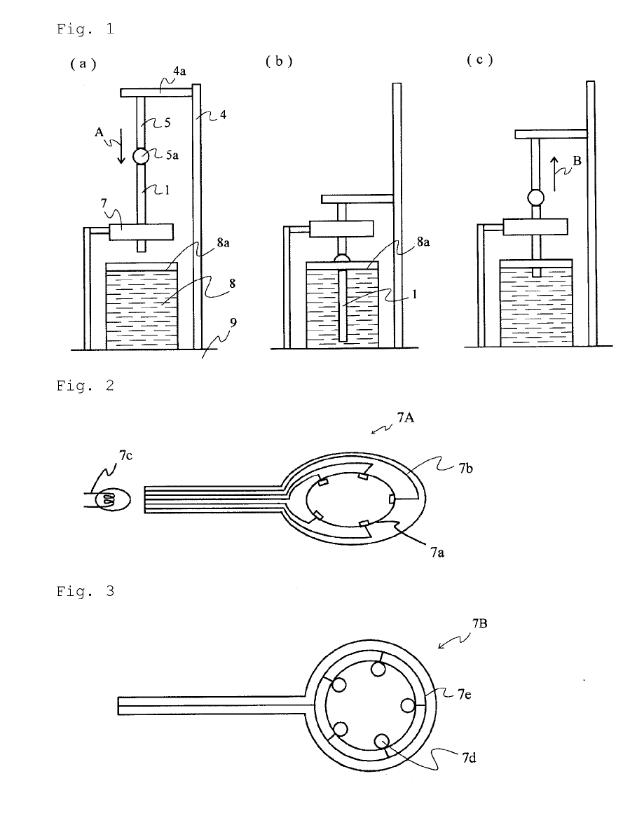

FIG. 1 is a drawing illustrating one example of operations of an apparatus for manufacturing an elastic layer of an electrifying roller. As shown in FIG. 1(a), the shaft 1 is retained by a shaft retaining mechanism 5 in a lift 4. The retaining method by a retaining member 5a of the shaft retaining mechanism 5 is not limited as long as the member can retain the shaft 1, and may be a method in which the shaft 1 is retained by clamping or a method in which the shaft 1 is retained by a strong magnet or the like.

On a pedestal 9 of the lift 4, a solution bath is placed into which a coating solution 8 containing an ultraviolet curing resin (hereinafter, also referred to as “UV coating”) is put. The size of the solution bath is not limited as long as the whole of the shaft 1 can be immersed. When the solution bath is large, a plurality of shafts 1 can be immersed at the same time and the cost can be reduced, which is preferable.

In the method of manufacturing an electrifying roller of the present invention, the shaft 1 is moved downward in the direction of arrow A in FIG. 1(a), that is, in a direction such that the longitudinal direction of the shaft 1 is perpendicular to the liquid level 8a of a UV coating 8, and immersed into the UV coating 8 (immersing process). At this time, as shown in FIG. 1(b), it is important that the shaft 1 is completely immersed in the UV coating 8 such that the top end of the shaft 1 on which an elastic layer is to be formed is below the liquid level 8a. The movement of the shaft 1 is performed, for example, by moving an arm portion 4a of the lift 4. Thus, by maintaining the shaft 1 perpendicular to the liquid level 8a, the film thickness can be made uniform, and an elastic roller having the same precision of film thickness (precision of deviation) as that in the conventional manufacturing method or more precision of film thickness can be manufactured.

In the method of manufacturing an electrifying roller of the present invention, the shaft 1 is lifted in the direction of arrow B in FIG. 1(c), that is, upward in the perpendicular direction after the immersing process, and at the same time an ultraviolet (hereinafter, also referred to as “UV”) is irradiated on the periphery of the lifted shaft 1 in the longitudinal direction, and an elastic layer is formed (ultraviolet irradiation process). The shaft 1 is lifted, for example, by moving the arm portion 4a of the lift 4 up and down in the same manner as described above. In the present invention, the shaft 1 is directly immersed into the UV coating 8 and lifted to reach an ultraviolet irradiation apparatus 7, and at the same time, an UV is irradiated on the shaft 1 to be cured, whereby an elastic layer can be manufactured in a very short time. Due to the dipping manufacturing method in which the UV coating 8 is immersed, an elastic layer can be manufactured without using a mold or a casting lid, and thus a highly precise electrifying roller can be manufactured at a low cost and with more ease.

In the present invention, irradiation of an ultraviolet is performed by an ultraviolet irradiation apparatus 7. Such an ultraviolet irradiation apparatus 7 has a ring shape by which a UV can be irradiated uniformly from the circumferential direction of a work, and the shaft 1 can be moved up and down through a hole portion at the center of the ring shape. FIG. 2 is a drawing illustrating one example of an ultraviolet irradiation apparatus. An ultraviolet irradiation apparatus 7A has an ultraviolet transparent lens 7a and an optical fiber 7b, and an ultraviolet generated from an ultraviolet generating apparatus (mercury lamp 7c) is irradiated from the ultraviolet transparent lens 7a through the optical fiber 7b. FIG. 3 is a drawing illustrating another example of an ultraviolet irradiation apparatus. An ultraviolet irradiation apparatus 7B has an LED 7d and a power cable 7e, and the LED 7d emits an ultraviolet to irradiate.

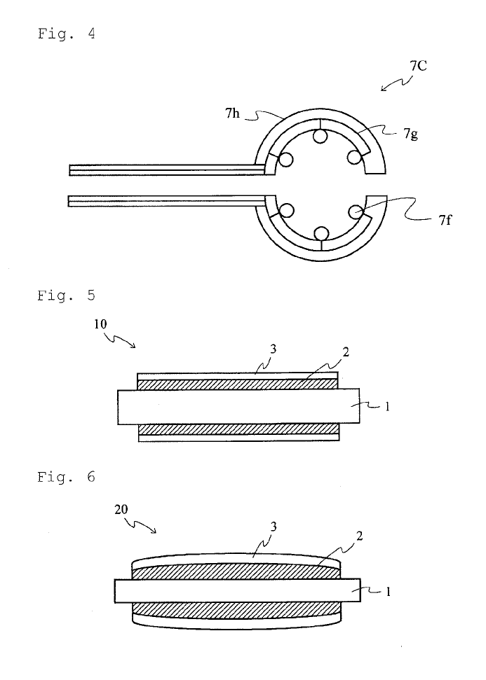

Further, FIG. 4 is a drawing illustrating another example of an ultraviolet irradiation apparatus, and a drawing illustrating a splittable ring-shaped ultraviolet irradiation apparatus. In FIG. 4, 7f is an ultraviolet transparent lens, and 7g is an optical fiber; and 7f may be an LED, and 7g may be a power cable. In an ultraviolet irradiation apparatus 7C, when an arm portion 4a of a lift 4 descends, a ring 7h is evacuated by dividing the ring so that the arm 4a does not collide with the ring, and when the arm portion 4a of the lift 4 ascends and the top end (work) of the shaft 1 reaches the height of the ultraviolet irradiation apparatus 7, the divided ring 7h comes together and irradiates an ultraviolet, whereby simplification of the shaft retaining mechanism 5 and relaxation of positional precision between ring 7h and a work can be attained.

In the method of manufacturing an electrifying roller of the present invention, an immersing process and an ultraviolet irradiation process are preferably performed once or a plurality of times, and more preferably one to three times. By this, a roller which has ever been manufactured by a urethane foam molding and multiple coatings of a water-based coating can be manufactured by coating the UV coating 8 in one to three layers, and the process can be simplified.

In the present invention, the irradiation intensity of the ultraviolet in the ultraviolet irradiation process is not limited as long as the UV coating 8 coated on the periphery of the shaft 1 can be cured, and preferably is at 0.1 to 4 W/cm². In the present invention, after the ultraviolet irradiation process at an ultraviolet irradiation intensity of 0.1 to 4 W/cm², an ultraviolet is preferably irradiated again on the elastic layer at an irradiation intensity of 120 to 240 W/cm². An elastic layer having a crown shape can be easily manufactured by using a method in which an ultraviolet irradiation is performed at an weak ultraviolet irradiation intensity in the ultraviolet irradiation process to cure the elastic layer to some degree, and thereafter, as the final process, an ultraviolet irradiation is performed again at an strong ultraviolet irradiation intensity to cure the elastic layer sufficiently.

In the present invention, the lifting speed of the shaft 1 upward in the perpendicular direction when the shaft 1 is lifted in a state where the shaft 1 is immersed in a coating solution after immersing process is not limited as long as the UV coating 8 can be coated on the periphery of the shaft 1. By adjusting the lifting speed, the film thickness can be changed as desired. The lifting speed is preferably 1.1 mm/s to 20 mm/s. By setting the speed in such a range, a uniform coating can be attained.

In the present invention, as the UV coating 8, those which contain the below-described ultraviolet curing resin may be used, and any other ingredients which can be used as an elastic layer of a normal electrifying roller can be added as long as the expected effect of the present invention is not damaged.

Further, in the present invention, the viscosity of the UV coating 8 is not limited as long as the UV coating 8 can be uniformly applied on the periphery of the shaft 1, and the viscosity of the UV coating 8 is preferably 0.5 to 10 Pa·s. By setting the viscosity in such a range, a more uniform coating can be attained.

In the present invention, the film thickness of the UV coating where the UV coating 8 is coated is preferably 0.5 to 2 mm, and more preferably, 0.9 to 1.3 mm. By setting the film thickness in such a range, an elastic layer having a crown shape can be easily manufactured.

The method of manufacturing an electrifying roller of the present invention necessitates formation of an elastic layer by an immersing process and an ultraviolet irradiation process. Therefore, the method of manufacturing the surface layer formed on an elastic layer is not particularly limited, and usually a method in which a coating solution in which the above-mentioned resins, electrically conductive materials and the like are dispersed or dissolved is prepared and this coating solution is applied by dipping method, spray method, roll coater method or the like to be subjected to heat curing is generally employed, and any of conventional water-base coating solution and solvent-based coating solution may be used. The solvent for preparing the coating solution may be suitably selected depending on the type of base resin which constitutes the resin composition or the like. For example, when fluorocarbon resin is employed as the base resin, methyl ethyl ketone (MEK), methyl isobutyl ketone (MIBK), toluene, xylene or the like may be preferably employed.

FIG. 4 is a drawing illustrating one example of an electrifying roller related to a preferred embodiment of the present invention. An electrifying roller 10 is a roller manufactured by the method of manufacturing an electrifying roller of the present invention, and comprises a shaft 1, an elastic layer 2 formed on the periphery of the shaft 1, and a surface layer 3 formed on the periphery surface of the elastic layer 2.

In the present invention, it is preferred that the ultraviolet curing resin be an ultraviolet curing resin which has the following characteristics (1) to (4):
(1) good adhesion to the shaft 1,
(2) a volume specific resistivity of 10⁶ to 10⁸ Ω·cm
(3) flexible and large breaking strength, and
(4) no bleed out of low-molecular electrically conductive material, although not restricted thereto as long as an intended effect of the present invention can be obtained. Thus, both characteristics of a foam elastic layer and a solid skin layer of the conventional electrifying roller can be attained in combination.

Examples of the above-mentioned ultraviolet curing resin include polyester resin, polyether resin, fluororesin, epoxy resin, amino resin, polyamide resin, acrylate resin, acrylic urethane resin, urethane resin, alkyd resin, phenol resin, melamine resin, urea resin, silicone resin, polyvinyl butyral resin, vinyl ether resin, vinyl ester resin, and modified resins into which a particular functionality is introduced thereto, and these resins may be used alone or two or more of these may be mixed to be used. The above-mentioned compound may comprise, other than the below-described electrically conductive material, a reactive diluent as required. The above-mentioned compound is preferred to comprise an photopolymerization initiator and photopolymerization accelerator. The compound may comprise other known additives as required.

As the ultraviolet curing resin, urethane acrylate ultraviolet curing resin composition comprising oligomers having a urethane structure and an ultraviolet polymerization initiator is particularly preferred.

In the present invention, as the electrically conductive materials which may be added to the ultraviolet curing resin of the elastic layer 2, suitable one may be employed. Carbon-based electrically conductive materials such as Ketjen black and acetylene black and carbon blacks for rubber such as SAF, ISAF, HAF, FEF, GPF, FT, MT may be used, and carbon blacks for ink such as oxidized carbon black, thermally decomposed carbon black, graphite, or the like may also be used.

High-polymer ionic electrically conductive materials may be added as the electrically conductive material, and as such a high-polymer ionic electrically conductive material, for example, those described in Japanese Unexamined Patent Application Publication No. 09-227717, Japanese Unexamined Patent Application Publication No. 10-120924 and Japanese Unexamined Patent Application Publication No. 2000-327922 may be used, but not limited thereto.

Concretely, a mixture of
(A) organic polymer material
(B) ion conducting polymer or copolymer and
(C) inorganic or low-molecular weight organic salts can be exemplified. Examples of component (A) include polyacrylic ester, polymethacrylic ester, polyacrylonitrile, polyvinyl alcohol, polyvinyl acetate, polyamide, polyurethane or polyester; examples of component (B) include oligoethoxylated acrylate or mathacrylate, oligoethoxylated styrene at the aromatic ring, polyether urethane, polyether urea, polyether amide, polyether ester amide or polyether ester; and
   examples of component (C) include alkaline metal, alkaline earth metal, zinc or ammonia salt of inorganic or low-molecular organic protonic acids, and component (C) is preferably LiClO₄, LiCF₃SO₃, NaClO₄, LiBF₄, NaBF₄, KBF₄, NaCF₄SO₃, KClO₄, KPF₆, KCF₃SO₃, KC₄F₉SO₃, Ca(ClO₄)₂, Ca(PF₆)₂, Mg(ClO₄)₂, Mg(CF₃SO₃)₂, Zn(ClO₄)₂, Zn(PF₆)₂, Ca(CF₃SO₃)₂ or the like.

The thickness of the elastic layer 2 of the electrifying roller 10 of the present invention is preferably 0.9 to 1.3 mm. A spark discharge can be prevented by setting the thickness of the elastic layer 2 in the above range. If the thickness of the elastic layer 2 is less than 0.9 mm, in a high temperature and low humidity area represented by Central America or the like, it is feared that a spark discharge occurs from a core bar (shaft) to a photoreceptor, which is not preferable. On the other hand, if the thickness of the elastic layer 2 is more than 1.3 mm, it becomes significantly difficult to control the external diameter of the roller during dipping application, which is not preferable since difference between the right side and the left side is likely to occur. If the difference between the external diameters of the roller at the right side and the left side is too large, adhesion of the electrifying roller to the photoreceptor becomes ununiform, and particularly adhesion of the electrifying roller to the photoreceptor at the side at which the external diameter is smaller becomes insufficient and charging ability cannot be fully exerted, therefore, it is feared that a problem of black patches occurs during an image evaluation.

In the present invention, as the shaft 1, those which are made of metal or plastic and in a hollow cylinder or solid cylinder shape may be used, and preferably, the shaft 1 is a hollow cylinder or solid cylinder made of metal, and more preferably, the shaft 1 is a hollow cylinder made of metal. By this, the cost can be reduced.

In the present invention, as the resin forming the surface layer 3, a resin which is usually used for an electrifying roller can be used. For example, the above-described ultraviolet curing resin and heat curing resin may be exemplified.

In the present invention, as the heat curing resin which can be used for the surface layer 3, known rubbers or resins used when the surface of an electrifying member is formed may be used, and although not limited thereto, urethane modified acrylic resins, polyurethane resins, acrylic resins, polyamide resins and fluororesins are exemplified and one or more of these may be mixed to be used. Among these, fluororesins are preferably used from the viewpoint that the surface of an electrifying roller can be provided with anti-toner adhesiveness.

As the fluororesins, concretely, polytetrafluoroethylene, tetrafluoroethylene perfluoro alkyl vinyl ether copolymer, tetrafluoroethylene ethylene copolymer, polychlorotrifluoroethylene resin, chlorotrifluoroethylene ethylene copolymer, tetrafluoroethylene vinylidene fluoride copolymer, poly vinylidene fluoride, polyvinyl fluoride and the like are exemplified.

In the resin which forms this surface layer 3, although not restricted thereto, an electrically conductive material may be added to provide or adjust the electric conductivity (electric resistance) on the surface layer. In this case, as the electric conductive material, although not restricted thereto, a variety of electric electrically conductive material or ionic electrically conductive material may be used, and particularly carbon is preferably used in the present invention.

The amount of the electrically conductive material added can be adjusted as appropriate so that a desired resistance is obtained. In this case, the volume specific resistivity of the surface layer 3 is preferably 1×10⁴ to 1×10¹² Ω·cm, particularly 1×10⁶ to 1×10⁸ Ω·cm, and the amount of the electrically conductive material added can be adjusted so that such a volume specific resistivity is attained. When carbon is employed as the electrically conductive material, the amount of the electrically conductive material added is usually about 1 to 100 phr, and particulaly about 10 to 70 phr based on a base resin.

To the resin composition which forms this surface layer 3, an additive such as cross linking agent, thickener, thixotropic agent or structural viscosity agent may be added as required.

The thickness of the surface layer 3 is set depending on the shape of the electrifying roller 10 or the like, and not particularly restricted thereto, and may be set usually 1 to 30 μm, particularly 1 to 20 μm. If the thickness is smaller than 1 μm, the durability of the roller is sometimes poor, and on the other hand, if the thickness is larger than 20 μm, there are cases where a good surface quality may not be obtained such as a case where charging characteristics is negatively affected and a case where wrinkle occurs on the surface.

FIG. 5 is a drawing illustrating another example of preferred embodiments of an electrifying roller of the present invention. Since it is important that a uniform working face be formed in the longitudinal direction when pressed on the photoconductor drum, the electrifying roller 20 has a crown shape whose diameter at the center portion is larger than those at the end portions. In the present invention, an elastic layer having a crown shape can be manufactured by applying the UV coating 8 by immersing. Concretely, an elastic layer having a desired crown shape can be manufactured by adjusting the speed of lifting a shaft and changing the thickness of the elastic layer in the roller axis direction as appropriate.

As a crown amount which represents the degree of the protrusion in which the portion at the center is more protruded than the portions at the ends in the roller length direction in the cross section of the roller length direction, 50 to 300 μm is preferably employed. By employing this amount, normal images may be made more preferable. If the crown amount is smaller than 50 μm, the contact pressure at the center of the roller in the roller length direction becomes low, while if the crown amount is larger than 300 μm, the portion at the center of the roller in the roller length direction makes too strong contact. Both cases possibly cause ununiformity of the charge amount. The measurement of the crown amount of the electrifying roller of the present invention was performed by using High Precision Laser Measuring Machine LSM-430v manufactured by Mitutoyo Co., Ltd. External diameters at the center portion and at 90 mm from the center portion in the direction from the center portion to the end portion were measured by this measuring machine, and a roller crown amount is defined as the difference between the external diameter at the center portion and the average of the external diameters at 90 mm from the center portion in the directions from the center portion to the end portions. For example, for an electrifying roller having a roller length of 250 mm, external diameters are measured at three point, at 35 mm, 125 mm and 215 mm from one end of the roller. In this case, the crown amount (μm) is calculated by the following formula (1):

crown amount(μm)={b−(A+C)/2}×1000 (1),

where the external diameter at 35 mm from one end of the roller is A (mm), the external diameter at 125 mm from one end of the roller is B (mm) and the external diameter at 215 mm from one end of the roller is C (mm).

In the present invention, the electrifying rollers 10 and 20 preferably have a deviation (precision of film thickness) of not larger than 70 μm in the whole range in the roller length direction. The electrifying rollers 10 and 20, and the photoreceptor are revolving while being in contact with each other, and when the deviation of the electrifying rollers 10 and 20 is large, a gap between the electrifying rollers 10 and 20, and the photoreceptor is generated. Further, the gap distance varies. In this case, toner particle and external additives which remain on the photoreceptor are likely to intrude into the gap and then attached irregularly on the electrifying rollers 10 and 20. As a result, the surface of the roller becomes mottled with the remain, which produces an image with a low quality. It is noted that the measurement of the deviation of the electrifying rollers 10 and 20 of the present invention was performed by using High Precision Laser Measuring Machine LSM-430v manufactured by Mitutoyo Co., Ltd. The external diameters for five points in the roller length direction were measured by this measuring machine, and a deviation was defined as the average of the difference between the maximum value and the minimum value of the measured external diameter for each point.

### EXAMPLES

The present invention will now be described in more detail in way of Examples.

### Examples 1 to 5

### (Manufacturing of Elastic Layer)

(1) An apparatus was used which has a tank having a depth which can immerse a hollow cylinder shaft 1 (material: aluminum A6063, length: 230 mm, thickness: 0.7 mm, external diameter φ: 18 mm), an ultraviolet irradiation apparatus 7 which is placed on the upper part of the tank, and a lift 4 which can retain the shaft 1 perpendicular to the liquid level (see FIG. 1).
(2) The tank was filled with a UV coating 8 having a viscosity of 5.100 Pa·s which has a formulation described in the Table 1 below, and the shaft 1 was placed on the lift 4.
(3) The shaft 1 was immersed (coated) in the tank by the lift 4, and thereafter lifted in a prescribed time (minutes) described in the Table 2 below. Each of the lifting speed was 4 mm/s.
(4) When the shaft 1 reaches the ultraviolet irradiation apparatus 7, an UV was irradiated on the shaft 1, and the UV coating was cured in a prescribed time (seconds) described in the Tables 2 and 3.
(5) The shaft 1 was lifted until the whole of the shaft 1 passed through the ultraviolet irradiation apparatus 7.
(6) In Examples 1 to 4, in order to obtain a needed film thickness or crown shape, the above operations (1) to (5) were performed twice in total.
(7) In order to complete the UV curing, in the final process, a 150 W/cm² of UV was irradiated by a UV lamp manufactured by Fusion UV Systems, Inc. while revolving a work.

### (Manufacturing of Surface Layer)

(1) In Examples 1 and 5, solvent-based coating having a formulation described in the Table 1 below was coated by immersing, subjected to air drying for 30 minutes, and thereafter subjected to heat drying in a heating furnace at a condition of 105° C. and 210 minutes to be cured. In Examples 2 and 4, a solvent-diluted UV coating having a formulation described in the Table 1 below and an emulsified water-based UV coating were coated by immersing, subjected to air drying for 30 minutes (in the case of a water-based coating, for 60 minutes), and thereafter subjected to UV irradiation to be cured. Further, in Example 3, a monomer-diluted UV coating having a formulation described in the Table 1 below were coated by immersing by using an apparatus having the lift 4 (see FIG. 1) in the same manner as in the manufacturing of the above-mentioned elastic layer, and UV cured at the same time of lifting, and then UV cured further.
(2) Cutting of end portion

At a prescribed position, the elastic layer and surface layer were cut to be removed, and a portion where the shaft 1 is exposed is made, thereby manufacturing the electrifying roller as shown in FIG. 5.

TABLE 1

| | | Examples 1 and 5 | | Example 2 | | Example 3 | | Example 4 | |
|---|---|---|---|---|---|---|---|---|---|
| Added | UV | GX-8454L*¹⁾ | 100 | GX-8454L*¹⁾ | 100 | GX-8454L*¹⁾ | 100 | GX-8454L*¹⁾ | 100 |
| ingredient | coating | Methoxy- | 20 | Methoxy- | 20 | Methoxy- | 20 | Methoxy- | 20 |
| (parts by | | triethylene | | triethylene | | triethylene | | triethylene | |
| mass) | | glycol acrylate | | glycol acrylate | | glycol acrylate | | glycol acrylate | |
| | | Sankonol*²⁾ | 0.5 | Sankonol*²⁾ | 0.5 | Sankonol*²⁾ | 0.5 | Sankonol*²⁾ | 0.5 |
| | | Irgacure 184*³⁾ | 0.5 | Irgacure 184*³⁾ | 0.5 | Irgacure 184*³⁾ | 0.5 | Irgacure 184*³⁾ | 0.5 |
| | Surface | Caprolactone | 100 | UV3200B*⁵⁾ | 80 | UF8001*⁷⁾ | 60 | R5002*¹⁰⁾ | 100 |
| | coating | modified acrylic | | Methyl ethyl ketone | 20 | AMO*⁸⁾ | 20 | purified water | 70 |
| | | urethane | | | | | | | |
| | | Nurate modified | 50 | | | IBXA*⁹⁾ | 20 | | |
| | | HDI*⁴⁾ | | | | | | | |
| | | Carbon black | 35 | BURNOCK 101-40*⁶⁾ | 10 | BURNOCK 101-40*⁶⁾ | 10 | BURNOCK 101-40*⁶⁾ | 10 |
| | | Methyl ethyl | 300 | Irgacure 184*³⁾ | 1 | Irgacure 184*³⁾ | 1 | Irgacure 1173*¹¹⁾ | 1 |
| | | ketone | | | | | | | |

*¹⁾Trade name: GX-8454L manufactured by Dai-ichi Kogyo Seiyaku Co., Ltd.
*²⁾Trade name: Sankonol manufactured by Sanko Chemical Ind. Co., Ltd.
*³⁾Trade name: Irgacure 184 manufactured by Ciba Specialty Chemicals KK
*⁴⁾nurate modified HDI (hexamethylene diisocyanate)
*⁵⁾Trade name: UV3200B manufactured by Nippon Synthetic Chemical Industry Co., Ltd.
*⁶⁾Trade name: BURNOCK 101-40 manufactured by DIC Corporation
*⁷⁾Trade name: UF8001 manufactured by KYOEISHA CHEMICAL Co., LTD.
*⁸⁾Trade name: AMO manufactured by Shin-Nakamura Chemical co., Ltd.
*⁹⁾Trade name: IBXA manufactured by KYOEISHA CHEMICAL Co., LTD.
*¹⁰⁾Trade name: R5002 manufactured by Dai-ichi Kogyo Seiyaku Co., Ltd.
*¹¹⁾Trade name: Irgacure 1173 manufactured by Ciba Specialty Chemicals KK

For the manufactured electrifying roller, the thickness of each layer, deviation, crown amount, and difference between the external diameters of the roller at the right side and the left side were measured, and the results are described in the Table 2 below.

### (Measurement of Deviation)

By using High Precision Laser Measuring Machine LSM-430v manufactured by Mitutoyo Corporation, external diameters for five points in the roller length direction were measured, and a deviation (mm) was defined as the average of the difference between the maximum value and the minimum value of the measured external diameter for each point.

### (Measurement of Crown Amount)

By using High Precision Laser Measuring Machine LSM-430v manufactured by Mitutoyo Corporation, external diameters at the center portion and at 90 mm from the center portion in the direction from the center portion to the end portion were measured, and a roller crown amount (μm) is defined as the difference between the external diameter at the center portion and the average of the external diameters at 90 mm from the center portion in the directions from the center portion to the end portions.

(Measurement of the Difference between the External Diameters of the Roller at the Right Side and the Left Side)

By using High Precision Laser Measuring Machine LSM-430v manufactured by Mitutoyo Corporation, external diameters at 90 mm from the center portion in the direction from the center portion to the end portion were measured, and the difference between the diameters at 90 mm to the end portions was calculated to define the difference (μm) between the external diameters of the roller at the right side and the left side.

TABLE 2

| | | Example 1 | | Example 2 | | Example 3 | |
|---|---|---|---|---|---|---|---|
| Manufacturing | Process | UV coating twice | 6 | UV coating twice | 6 | UV coating twice | 6 |
| time (minutes) | | Lifting thereafter | | Lifting thereafter | | Lifting thereafter | |
| | | (twice in total) | | (twice in total) | | (twice in total) | |
| | | UV irradiation | 0.08 | UV irradiation | 0.08 | UV irradiation | 0.08 |
| | | Coating on surface | 240 | Coating on surface | 33 | Coating on surface | 3 |
| | | layer once Solvent- | | layer once Solvent- | | layer once Solvent- | |
| | | based coating - Heat | | diluted UV coating | | diluted UV coating | |
| | | curing | | dipping | | dipping | |
| | | Cutting of end portion | 1 | Cutting of end portion | 1 | Cutting of end portion | 1 |

| | Total time | 247 | | 40 | | 10 | |
|---|---|---|---|---|---|---|---|
| Evaluation | Film thickness | UV elastic layer 1.3 mm | | UV elastic layer 1.3 mm | | UV elastic layer 1.3 mm | |
| | | Surface layer 7 μm | | Surface layer 8 μm | | Surface layer 8 μm | |
| | Deviation | 0.030 | mm | 0.034 | mm | 0.029 | mm |
| | Crown amount | 92 | μm | 83 | μm | 87 | μm |
| | Difference | 3 | μm | 5 | μm | 4 | μm |
| | between the | | | | | | |
| | external | | | | | | |
| | diameters of the | | | | | | |
| | roller at the | | | | | | |
| | right side and | | | | | | |
| | the left side | | | | | | |

TABLE 3

| | | Example 4 | | Example 5 | |
|---|---|---|---|---|---|
| Manufacturing | Process | UV coating twice Lifting | 6 | UV coating twice Lifting | 3 |
| time (minutes) | | thereafter (twice in total) | | thereafter (twice in total) | |
| | | UV irradiation | 0.08 | UV irradiation | 0.08 |
| | | Coating on surface layer once | 63 | Coating on surface layer once | 240 |
| | | Solvent-diluted UV | | Solvent-based coating- | |
| | | coating dipping | | Heat curing | |
| | | Cutting of end portion | 1 | Cutting of end portion | 1 |
| | Total time | | 70 | | 244 |

| | | | |
|---|---|---|---|
| Evaluation | Film thickness | UV elastic layer 1.3 mm | UV elastic layer 0.81 mm |
| | | Surface layer 8 μm | Surface layer 7 μm |
| | Deviation | 0.031 mm | 0.140 mm |
| | Crown amount | 102 μm | 292 μm |
| | Difference | 8 μm | 221 μm |
| | between the | | |
| | external | | |
| | diameters of | | |
| | the roller at the | | |
| | right side and | | |
| | the left side | | |

In Examples 1 to 4, an electrifying roller can be manufactured at a low cost and with more ease. A highly precise electrifying roller which has a small deviation and a suitable amount of crown amount can be manufactured. In the roller of Example 5, in order to adhere a required amount of the resin during one immersing process or an ultraviolet irradiation process, the amount of the coating becomes high, and a slight dripping downward along the axis of the shaft occurred when lifting, and as a result, deviation and difference between the external diameters of the roller at the right side and the left side became a slightly large.

### Reference Examples 1 to 9

Next, in order to verify the condition of the formed elastic layer when the conditions in the immersing process and in the ultraviolet irradiation process were changed, an elastic layer was formed in the same manner as in Example 1 except for the formulation of the solvent-based coating as shown in the Table 4 below. For the obtained elastic layer, the film thickness, crown amount and difference between the external diameters of the roller at the right side and the left side were measured. The results in combination with the presence or absence of tackiness on the surface of the elastic layers are shown in the Tables 5 and 6.

TABLE 4

| | | Refer- | | | |
|---|---|---|---|---|---|
| | | ence | Refer- | Refer- | Refer- |
| | | Exam- | ence | ence | ence |
| | | ples 1 to | Exam- | Exam- | Exam- |
| | | 5 and 8 | ple 6 | ple 7 | ple 9 |
| UV | GX-8454L*¹⁾ | 100 | 100 | 100 | 100 |
| coating | Methoxy- | 40 | 10 | 100 | 150 |
| fomulation | triethylene | | | | |
| ingredient | glycol acrylate | | | | |
| (parts by | Sankonol*²⁾ | 0.5 | 0.5 | 0.5 | 0.5 |
| mass) | Irgacure 184*³⁾ | 0.5 | 0.5 | 0.5 | 0.5 |

TABLE 5

| | | Refer- | Refer- | Refer- | Refer- |
|---|---|---|---|---|---|
| | | ence | ence | ence | ence |
| | | Exam- | Exam- | Exam- | Exam- |
| | | ple 1 | ple 2 | ple 3 | ple 4 |
| Ultra- | Ultraviolet irradiation | 0.15 | 3.5 | 3.5 | 3.5 |
| violet | process | | | | |
| irradi- | (UV coating twice) | | | | |
| ation | Final process | 120 | 120 | 240 | 50 |
| intensity | | | | | |
| (W/cm²) | | | | | |
| Evalu- | Film thickness of UV | 1.3 mm | 1.3 mm | 1.3 mm | 1.3 mm |
| ation | elastic layer | | | | |
| | Crown amount | 94 μm | 92 μm | 97 μm | 94 μm |
| | Difference between | 7 μm | 3 μm | 5 μm | 3 μm |
| | the external diameters | | | | |
| | of the roller at the right | | | | |
| | side and the left side | | | | |
| | Tackiness | No | No | No | Yes |

As shown in the Table 5, in the Reference Example 4 in which the ultraviolet irradiation intensity in the final process was set low, a slight tackiness occurred on the surface of the elastic layer.

TABLE 6

| | | Reference | | Reference | | Reference | | Reference | | Reference | |
|---|---|---|---|---|---|---|---|---|---|---|---|
| | | Example 5 | | Example 6 | | Example 7 | | Example 8 | | Example 9 | |
| Number of UV coatings | | 2 | | 2 | | 2 | | 2 | | 2 | |
| Lifting speed (mm/s) | | 4 | | 1.1 | | 20 | | 0.5 | | 20 | |
| Viscosity of coating (Pa · s) | | 2 | | 9 | | 0.7 | | 2 | | 0.3 | |
| Evaluation | Film thickness | 1.3 | mm | 1.9 | mm | 1.2 | mm | 0.7 | mm | 0.5 | mm |
| | of UV elastic | | | | | | | | | | |
| | layer | | | | | | | | | | |
| | Crown amount | 94 | μm | 112 | μm | 79 | μm | 20 | μm | 13 | μm |
| | Difference | 7 | μm | 10 | μm | 4 | μm | 120 | μm | 254 | μm |
| | between the | | | | | | | | | | |
| | external | | | | | | | | | | |
| | diameters of | | | | | | | | | | |
| | the roller at | | | | | | | | | | |
| | the right side | | | | | | | | | | |
| | and the left | | | | | | | | | | |
| | side | | | | | | | | | | |

| | | | | | |
|---|---|---|---|---|---|
| Tackiness | No | No | No | No | No |

As shown in the Table 6, when the viscosities of the coatings are the same, the higher the lifting speed is, the larger the film thickness of the elastic layer becomes and the lower the lifting speed is, the smaller the film thickness of the elastic layer becomes (Reference Example 5, 8). On the other hand, when the lifting speeds are the same, the higher the viscosity of the coating is, the larger the film thickness of the elastic layer becomes and the lower the viscosity of the coating is, the smaller the film thickness of the elastic layer becomes (Reference Example 7, 9). Accordingly, since the film thickness of the obtained elastic layer depends on both the lifting speeds and the viscosity of the coating and too large film thickness tends to cause insufficient curing, it is found to be important that both the lifting speed and the viscosity of the coating be set such that a suitable film thickness is obtained. In the electrifying roller in which the elastic layer of the Reference Example 8 and 9 is used, since the film thickness of the elastic layer was thin, an electric discharge occurred between the shaft of the electrifying roller and a photoreceptor.

### DESCRIPTION OF SYMBOLS

1 shaft
2 elastic layer
3 surface layer
4 lift
4a arm portion
5 shaft retaining mechanism
5a retaining member
7 ultraviolet irradiation apparatus
7A, 7B, 7C ultraviolet irradiation apparatus
7a, 7f ultraviolet transparent lens
7b, 7g optical fiber
7c mercury lamp
7d LED
7e power cable
7h ring
8 coating solution containing ultraviolet curing resin (UV coating)
8a liquid level
9 pedestal of lift
10, 20 electrifying roller

1. A method of manufacturing an electrifying roller comprising a shaft, an elastic layer formed on the periphery of said shaft, and a surface layer formed on the periphery surface of said elastic layer, wherein the method comprises:
an immersing process in which said shaft is moved downward so that the longitudinal direction of said shaft be perpendicular to the liquid level of a coating solution containing an ultraviolet curing resin and immersed into said coating solution, and
an ultraviolet irradiation process in which said shaft is lifted upward in the perpendicular direction after said immersing process, and at the same time an ultraviolet is irradiated on the periphery of lifted said shaft in the longitudinal direction, and said elastic layer is formed.

2. The method of manufacturing an electrifying roller according to claim 1, wherein said immersing process and said ultraviolet irradiation process are performed in a plurality of times.

3. The method of manufacturing an electrifying roller according to claim 1, wherein the irradiation intensity of the ultraviolet in said ultraviolet irradiation process is set at 0.1 to 4 W/cm², and after said ultraviolet irradiation process, an ultraviolet is irradiated again on said elastic layer at an irradiation intensity of 120 to 240 W/cm².

4. The method of manufacturing an electrifying roller according to claim 1, wherein the lifting speed of said shaft upward in the perpendicular direction after said immersing process is 1.1 mm/s to 20 mm/s.

5. The method of manufacturing an electrifying roller according to claim 1, wherein the viscosity of said coating solution is 0.5 to 10 Pa·s.

6. An electrifying roller characterized in that the roller is manufactured by the method of manufacturing an electrifying roller according to claim 1.
